(19) United States
(12) Patent Application Publication
(10) Pub. No.: US 2021/0361108 A1
(43) Pub. Date: Nov. 25, 2021

(54) METHOD AND DEVICE FOR BEVERAGE MAKING

(71) Applicant: EKSEN MAKINE SANAYI VE TICARET A.S., Kocaeli (TR)

(72) Inventor: Ragip Okan OZGE, KOCAELI (TR)

(73) Assignee: EKSEN MAKINE SANAYI VE TICARET A.S., Kocaeli (TR)

(21) Appl. No.: 16/652,685

(22) PCT Filed: Aug. 16, 2018
(86) PCT No.: PCT/EP2018/072199

§ 371 Date: Apr. 1, 2020

(30) Foreign Application Priority Data
Aug. 24, 2017 (EP) 17187825.9

(51) Int. Cl. A47J 31/04; A47J 31/44; A47J 31/52; A47J 31/46

(52) U.S. Cl. CPC A47J 31/04; A47J 31/468; A47J 31/5253; A47J 31/4439

(57) ABSTRACT

A device for making a beverage particularly a coffee-based beverage, comprising an electronic control unit; a portable cooking pot having a bottom and an open top for receiving a mixture that is added to the cooking pot to make the beverage, in which a cooking process is performed; a heating means for heating the cooking pot during the cooking process; and an infrared temperature sensor for contactless sensing the temperature in the cooking pot. Said infrared temperature sensor is configured to detect the temperature of an upper surface of the mixture during the cooking process and said infrared temperature sensor is disposed in proximity to the cooking pot, at a distance such as to allow the measurement of the temperature of the upper surface of the mixture contactless.

### TECHNICAL FIELD OF THE INVENTION

The present invention relates to a beverage device for making beverage such as a coffee or the like, and more particularly relates to a beverage device having an infrared temperature sensor which sense the temperature of the beverage contactless.

### BACKGROUND OF THE INVENTION

The quality of the beverage depends on a number of factors, including the quality of the coffee or the like, the temperature of the water, and the period of heating time of the beverage that is prepared.

It is necessary to constantly control the cooking process of beverages such as a Turkish coffee or milk that tend to overflow during cooking. For example, when making the Turkish coffee, a significant amount of froth is produced when it is close to the boiling point and the froth is increased instantaneously and sharply. The rising of the froth has to be controlled and the heating process has to be finished before boiling phase. In the state of art, a cooking pot is taken to a predetermined temperature by means of heating means and when the desired froth level is reached and the cooking process is over. Even though the energy transmitted to the heating means is turned off immediately in order to stop heat transmission, the heat transmission to the cooking pot continues due to the thermal inertia of the heating means, thus the beverage reaches boiling point by being over heated than the required level and the desired flavor of the beverage cannot be obtained. One of the main problems is that preventing an overflow of the ingredients in the end of the heating process. This is typically achieved by regulating the heat energy transferred to the cooking pot, i.e. by reducing power consumption of the heating means.

In some devices, an automatic detection of the froth formation of the beverage is controlled by measuring the steam temperature with NTC thermistors which are non-linear resistors, and which alter their resistance characteristics with temperature. However, in such devices, ambient temperature and the amount of the cooked beverage change the amount of heat, which makes it difficult to sense the correct temperature value accurately.

Further, in some devices, automatic froth detection is controlled with a sensor that detects the light intensity. However, in a similar manner, a problem of such devices is that it is needed that the formation of the froth and rise in the level of the froth. Such device does not measure the beverage temperature precisely, but works with respect to the formation of the froth. This may result in problems such as overheating when the froth is not formed.

A prior art publication in the technical field of the present invention may be referred to as EP1763311 (B1) among others, the document disclosing a coffee machine having an infrared sensor is set to detect the initial level of the mixture, which is composed in order to make Turkish coffee in a boiling pot in amounts according to the cup size and cup quantity wherein Turkish coffee is to be served, and the froth height limit that every mixture at an initial level will reach after the boiling process. However, a problem of such devices is that, likewise, it is needed that the formation of the froth and rise in the level of the froth. Further, in such devices where this method is used, the heat that accumulates on the resistance leads to excessive overflow. For this reason it is necessary to use the systems that will separate the cooking pot with the heating means after a certain level.

In the market, most of the device use similar type resistances that are used because of economic and technical parameters in which the thermal inertia accumulates on the resistance causes various problems to be solved.

### OBJECTS OF THE INVENTION

The present invention is based on the general idea of providing a temperature sensing device comprising at least one infrared sensor, by means of which the liquid temperature in the cooking pot can be sensed accurately, in a device for household appliance, in particular for further use in an automated Turkish coffee preparation machine.

Primary object of the present invention is to provide a beverage device for making beverages with a sensor by means of which the beverage temperature can be sensed accurately.

Another object of the present invention is to provide a beverage device for detecting the froth accurately. Cooking time is determined by predicting the heat mass that accumulates on the heating element.

Another object of the present invention is to provide a beverage device which is adapted to control heat input during the coffee cooking period which ensures that the desired flavor is obtained.

Another object of the present invention is to provide a beverage device which prevents the extra heat input, which can lead to excessive foaming, and every time the cooked quality foams are obtained.

Another object of the present invention is to provide a beverage device which provides a homogeneous mixing in the cooking pot by mixing the ingredients in the cooking pot through a water jet.

### SUMMARY OF THE INVENTION

The present invention proposes a beverage device for making a beverage, particularly a coffee-based beverage, comprising: an electronic control unit; a portable cooking pot having a bottom and an open top for receiving a mixture that is added to the cooking pot to make the beverage, in which a cooking process is performed; a heating means for heating the cooking pot during the cooking process; and an infrared temperature sensor for contactless sensing the temperature in the cooking pot. Said infrared temperature sensor is configured to detect the temperature of an upper surface of the mixture during the cooking process and said infrared temperature sensor is disposed in proximity to the cooking pot, at a distance such as to allow the measurement of the temperature of the upper surface of the mixture contactless wherein said electronic control unit reduces or cuts off power transferred to said heating means when a predefined temperature value is reached based on the temperature value obtained from the infrared temperature sensor.

In an alternative embodiment, said electronic control unit is configured to pause the cooking process by cutting off or reducing the energy transmission to the cooking pot when the mixture reaches a predetermined temperature wherein the cooking pot is maintained from 30 to 60° C. for a period of time selected between 5 to 30 seconds. In another embodiment, the cooking pot can be maintained from 30 to 100° C. for a period of time predefined according to the type of the prepared mixture.

In an alternative embodiment, said device comprises a water reservoir for storing water and a pump which is adapted to transfer the water in the water reservoir to the cooking pot.

In an alternative embodiment, said beverage device comprises at least one spraying head, which enables the mixing of the mixture in the cooking pot by means of water jet.

In an alternative embodiment, said spraying head comprises at least one spray opening through which the water jet passes wherein said at least one spray opening is configured to spray the water to the mixture at an angle (a) between 10 and 60 degrees relative to a longitudinal axis of the device before or during the cooking process.

In an alternative embodiment, said beverage device comprises a temperature sensor which is arranged to measure and control the temperature of the bottom surface of the heating means thereby overheating of the heating means is eliminated.

In an alternative embodiment, said beverage device comprises a stirrer which is suitable to be positioned in the cooking pot, and a drive means configured to actuate the stirrer wherein said drive means and the stirrer are configured in such a way that the stirrer is driven in order to mix the mixture in the cooking pot, through a magnetic drive effect.

In an alternative embodiment, the electronic control unit is configured in such a way as to actuate the said drive means, and therefore magnetically drive said stirrer at a speed to mix the mixture during the cooking process or before the cooking process in a specified period of time.

In an alternative embodiment, said drive means comprises a drive portion in a magnetic communication with the stirrer and a motor which is electrically powered, a spindle of the motor rotation drives the drive portion and this creates a rotary local magnetic field, collaborating with an embedded upper magnet of the stirrer and embedded lower magnet of the drive portion and this as a result causes the stirrer to rotate.

In an alternative embodiment, said beverage device comprises a switch which is configured to detect the placement of the cooking pot in the device before the cooking process is started.

In an alternative embodiment, said beverage device comprises a raising means which allows the heating means to be lifted in such a way as to contact the cooking pot to increase the thermal efficiency during the cooking process wherein said raising means actuates the heating means in downwards direction when the cooking process is completed.

In an alternative embodiment, the raising means comprises a mechanic arm in a communication with a motor which provides the contact of the heating means to the bottom of the boiling pot by a certain pressure force by moving in the upwards direction during the cooking process.

In an alternative embodiment, the electronic control circuit has a temperature algorithm that calculates the inner temperature value of the mixture and when the mixture will boil during the cooking process with respect to the temperature of the upper surface of the mixture that is sensed by the infrared temperature sensor, wherein the temperature algorithm calculates the inner temperature of the mixture depends on the type of the beverage to be prepared and the type of the heating means.

In an alternative embodiment, said an infrared temperature sensor is disposed in the cooking pot for contactless sensing the temperature in the cooking pot and said heating means is disposed on a bottom portion of the cooking pot wherein said cooking pot is placed onto a stand during the cooking process.

A beverage, particularly a coffee-based beverage, preparation method for a beverage device comprises a step of adding ingredients of the mixture to the cooking pot to make the beverage; a step of placing the cooking pot in the beverage device; a step of actuating the device; a step of actuating the cooking process by transmitting energy to the heating means; a step of measuring the temperature of the upper surface of the mixture in the cooking pot by means of the infrared temperature sensor contactless; a step of terminating the cooking process by cutting off the energy transmitted from the heating means to the cooking pot when a predefined temperature value is reached based on the temperature data obtained from the infrared temperature sensor. Said method further comprises: a step during which the temperature between 30 and 100° C. is maintained for a period of time depending on type of the beverage to be prepared; and a step of terminating the cooking process by cutting off the energy transmitted from the heating means to the cooking pot before the temperature of the mixture exceeds 100° C.

### BRIEF DESCRIPTION OF THE FIGURES

Accompanying drawings are given solely for the purpose of exemplifying a beverage device for beverage making whose advantages over prior art were outlined above and will be explained in detail hereinafter:

FIG. 1 demonstrates a front view of the beverage device according to the present invention;

FIG. 2 demonstrates a perspective view of the beverage device according to the present invention;

FIG. 3 demonstrates a side view of the beverage device according to the present invention;

FIG. 4 demonstrates a front view of another embodiment of the beverage device according to the present invention;

FIG. 5 shows a view in section on A-A of the FIG. 4 wherein a raising means is shown.

FIG. 6 shows a cross sectional view according to another embodiment of the beverage device.

FIG. 7 shows a cross sectional view according to another embodiment of the beverage device.

FIG. 8 shows a cross sectional view according to another embodiment of the beverage device having a stand on which the cooking pot is placed.

### DETAILED DESCRIPTION OF THE INVENTION

### Reference List

10. Beverage device
15. Main body
20. Cooking pot
21. Mixture
22. Handle
23. Upper surface
30. Water reservoir
31. Water
32. Pump
40. Motor
41. Drive means
42. Heating means
43. Drive portion
43a. Lower magnet
44. Stirrer
44a. Upper magnet
50. Infrared temperature sensor
60. Spraying head
61. Water jet
70. Raising means
80. Base portion

According to the present invention a beverage device (10) for making a beverage, particularly a coffee-based beverage, is proposed. Said beverage device (10) mainly comprises an electronic control unit; a portable cooking pot (20) having a bottom and an open top for receiving a mixture (21) that is added to the cooking pot (20) to make the beverage, in which a cooking process is performed; a heating means (42) for heating the cooking pot (20) during the cooking process; and an infrared temperature sensor (50) for contactless sensing the temperature in the cooking pot (20). According to the invention, said infrared temperature sensor (50) is configured to detect the temperature of an upper surface (23) of the mixture (21) during the cooking process and said infrared temperature sensor (50) is disposed in proximity to the cooking pot, at a distance such as to allow the measurement of the temperature of the upper surface (23) of the mixture (21) contactless wherein said electronic control unit reduces or cuts off power transferred to said heating means (42) when a predefined temperature value is reached based on the temperature value obtained from the infrared temperature sensor (50). A thermopile sensor can be used as an infrared temperature sensor (50) that converts thermal energy into electrical energy. Said thermopile sensor can be composed of several thermocouples connected usually in series or, less commonly, in parallel. The thermocouples operate by measuring the temperature differential from their junction point to the point in which the thermocouple output voltage is measured. Thermocouples can be connected in series as thermocouple pairs with a junction located on either side of a thermal resistance layer. In particular, the infrared temperature sensor (50) can detect the wavelength of the radiation captured and from this it is possible to obtain the temperature. The electronic control unit is adapted to manage the various components of the beverage device (10) and in particular to control the heating means (42), pump (32), the drive means (41) and related stirrer (44).

According to the present invention, the temperature of the mixture (21) in the cooking pot (20) is controlled by the infrared temperature sensor (50) which can contactless sense the temperature of the upper surface (23) of the mixture (21) without interference during the cooking process. When the upper surface (23) temperature of the mixture (21) reaches a desired value, the cooking process is automatically terminated, reduced or paused by means of the electronic control unit through heating means (42).

The infrared temperature sensor (50) determines to initiate the boiling process by detecting the temperature of the mixture (21) having ingredients such as water, coffee or the like and sugar. Said mixture (21) is added to the cooking pot (20) in defined quantities and said infrared temperature sensor (50) is adapted to conclude the cooking process by sensing the upper surface (23) of the mixture (21) when the heating process is concluded. The upper surface (23) of the coffee-based or the like mixture (21) does not behave like water. A residue accumulates on the surface of the mixture (21), which shields the temperature of the mixture (21) at the bottom of the cooking pot (20). As the mixture (21) reaches the cooking level, the upper surface (23) temperature gradually heats up and when the mixture (21) reaches the desired cooking level, and the mixture (21) begins to boil and froth starts to form. When the upper surface (23) temperature reaches to the temperatures before the boiling temperature, i.e., between 70-95° C., the energy transmitted from the heating means (42) to the cooking pot (20) is cut off, reduced or paused. Said cooking pot (20) is preferably used with a handle (22) for holding by the user as shown in the figures.

As the cooking time of the mixture (21) is increased, the mixture (i.e. the coffee, milk-based beverage or Turkish coffee) dissolves more in water, changing the flavor. The taste perception varies according to the person and the habits. When the upper surface temperature of the coffee-based mixture (21) reaches the predetermined temperature (i.e., 30-60° C. or 30-100° C.) before the initial boiling, the cooking process is interrupted and the mixture is kept at the determined temperature values or times (i.e., 5 Sec-20 Sec) and then the cooking process is continued. In this way the desired flavor can be reached. The preset values can be used on the beverage device (10) as an option for the user taste selection.

As a result of the tests and analyzes, it is discovered that the upper surface of the mixture temperature, and the inner portion of the mixture temperature are very different compared to each other. According to the present invention, said electronic control unit has a temperature algorithm that calculates the temperature values from the upper surface of the mixture that is sensed by the infrared sensor and the temperature at which the temperature of the inner portion of the mixture is at what level and when it will bring to the boiling point. For example: depending on the type of the heating means, a 5° C. temperature change in the upper surface can be equivalent to a 30 degree temperature change in the liquid-based mixture inside. With the developed temperature algorithm, Turkish coffee or the like can be prepared at the desired level by just calculating the temperature values in the upper surface (23).

Referring to the FIG. 6, in a possible embodiment of the present invention, a water reservoir (30) for storing water and a pump (32) can be adapted to transfer the water (31) in the water reservoir (30) to the cooking pot (20). Said reservoir (30) can be attached to the main body of the beverage device (10) and removed from the main body (15). Further, the water level in the water reservoir (30) can be controlled by a water level sensor. If the quantity of water in the reservoir (30) is below a predetermined level, a vocal and/or visual warning is given and the cooking process cannot be actuated.

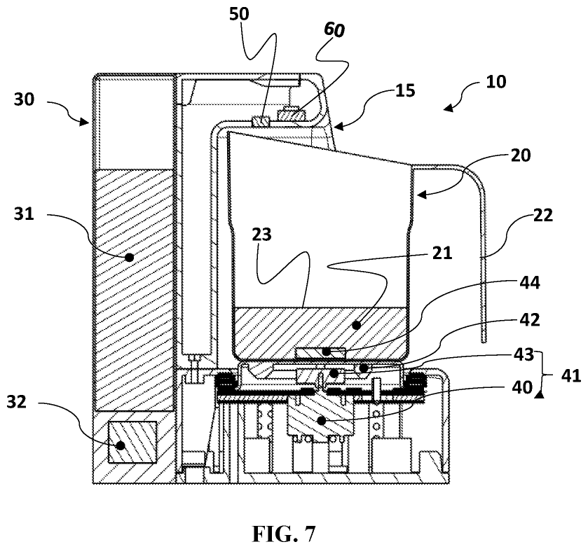

In a possible embodiment of the present invention, the beverage device (10) can have at least one spraying head (60) which enables the mixing of the mixture (21) in the cooking pot (20) by means of water jet (61). Said at least one spraying head (60) can be positioned at the upper portion of the main body (15) facing to the cooking pot (20). The spraying head (60) can have at least one spray opening (63) through which the water jet passes wherein said at least one spray opening (63) is configured to spray the water to the mixture at an angle (a) between 10 and 60 degrees relative to a longitudinal axis (X) of the beverage device (10) before or during the cooking process. The water jet sprays at a certain angle to the cooking pot (20), so that a more homogeneous mixture is obtained. Further, the spray openings (63) can be positioned at different angles and positions. The required amount of coffee, water and sugar as desired can be mixed homogeneously prior cooking or boiling by means of the water ejected through the spray opening (63). The beverage device (10) is very easy to use and clean as the cooking pot (20) is not integrated with the main body (15) and with the heating means like the resistance (as shown in FIG. 7) and can be easily attached and removed.

In a possible embodiment of the present invention, the temperature of the bottom of the heating means (42) can be measured by a temperature sensor that can be added to limit and control the heating means (42). The temperature sensor is arranged to measure and control the temperature of the bottom surface of the heating means (42) thereby overheating of the heating means (42) can be eliminated. This sensor can be any sensor that can measure temperature by contact or contact.

Again referring to the FIGS. 6 and 7, a stirrer (44) and a drive means for actuating the stirrer can be used in an alternative embodiments of the present invention. Said stirrer is suitable to be positioned in the cooking pot (20) before the cooking process is started. The drive means (41) are configured to actuate the stirrer (44) wherein said drive means (41) and the stirrer (44) are configured in such a way that the stirrer (44) is driven in order to mix the mixture in the cooking pot (20), through a magnetic drive effect. The electronic control unit is configured in such a way as to actuate the said drive means (41), and therefore magnetic drive said stirrer (44) at a speed to mix the mixture (21) during the cooking process or before the cooking process during a specified period of time. Further, the drive means (41) can have a drive portion (43) in a magnetic communication with the stirrer (44) and a motor (40) which is electrically powered, a spindle of the motor (40) rotationally drives the drive portion (43) and this creates a rotary local magnetic field, collaborating with an embedded upper magnet (44a) of the stirrer (44) and embedded lower magnet (43a) of the drive portion (43) and this as a result causes the stirrer to rotate. The drive means can be fixed to the lower portion of the main body (15) of the device (10). Further, a positioning element can be used for positioning the stirrer during the use that ensures the stirrer is correctly in place locally in the magnetic field. Such position element helps to prevent the stirrer from leaving the field before, during or after the stirring operation. In some embodiments, the cooking pot (20) can be produced with the positioning element in which stirrer (44) just placed into the cooking pot (20). The stirrer can have at least one upper magnet (44a) made of ferromagnetic material such as a pair of magnets which are housed in a plastic support which may be injection-molded around the magnets.

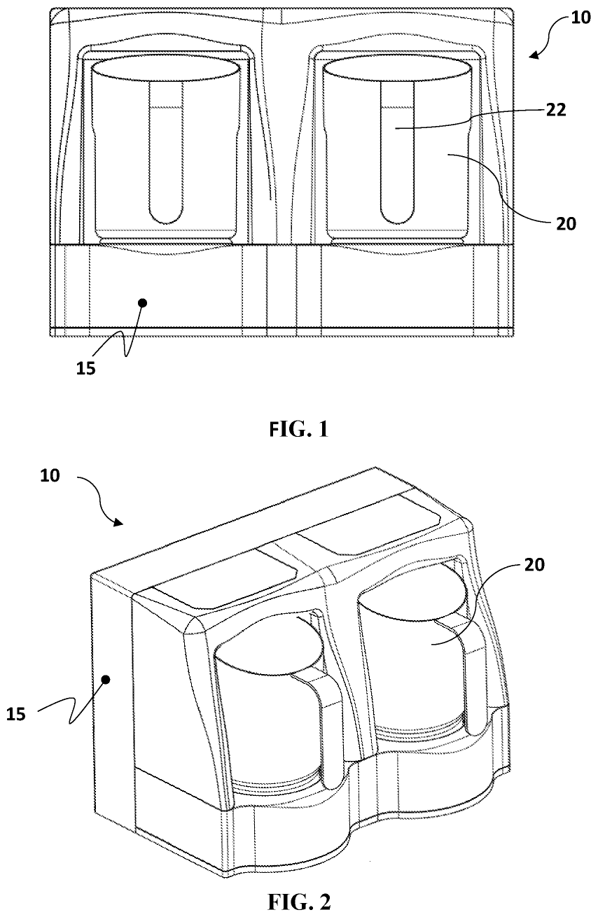

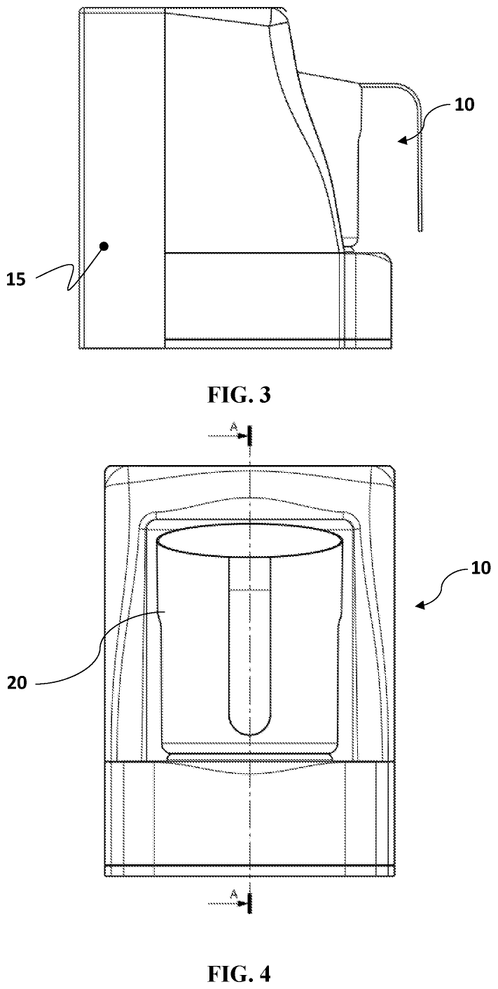

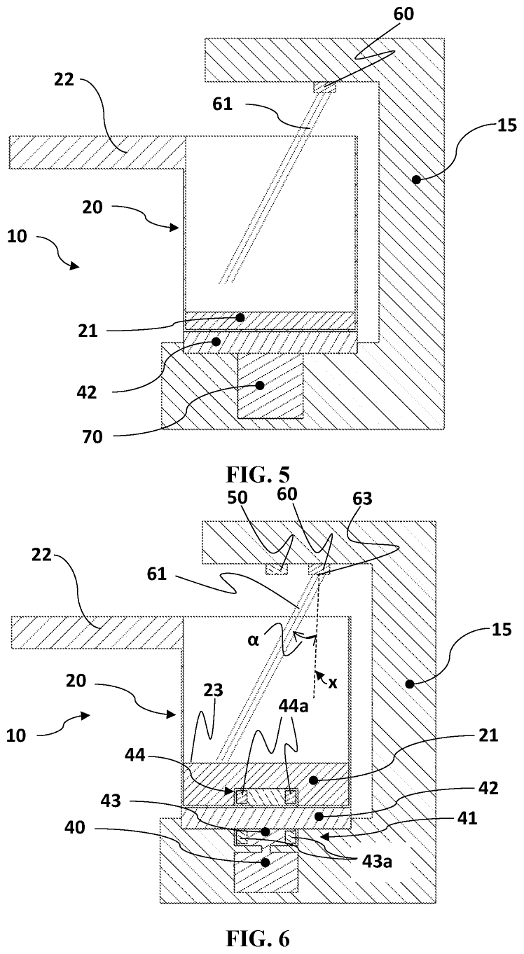

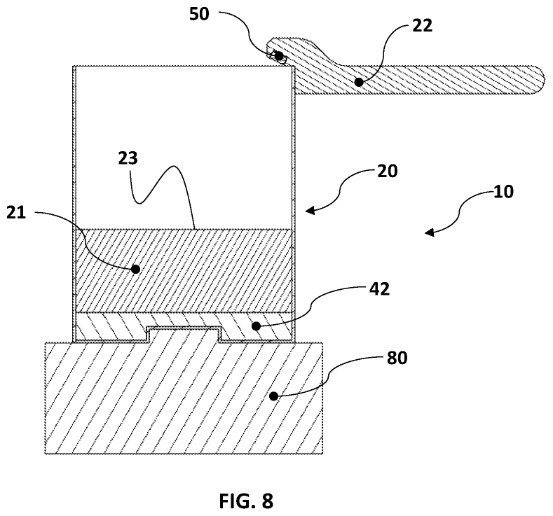

Referring to the FIG. 1-7, the beverage device (10) has a main body (15) into which a portable cooking pot (20) is placeable. In a possible embodiment of the present invention, the beverage device (10) can be designed as a single unit which can be placeable onto a base portion (80) having an electrical connector which is in a communication with the cooking pot (20) during the cooking process, as shown in FIG. 8. Referring to the FIG. 8, the cooking pot (20) can include heating means (42) at the bottom portion thereof into which the mixture (21) is added. Again referring to the FIG. 8, said infrared temperature sensor (50) is configured to detect the temperature of an upper surface (23) of the mixture (21) during the cooking process and said infrared temperature sensor (50) is disposed in proximity to the cooking pot, at a distance such as to allow the measurement of the temperature of the upper surface (23) of the mixture (21) contactless. Said infrared temperature sensor (50) can be provided at one end of a handle (22) of the cooking pot (20) facing to the inner portion of the cooking pot with a certain angle, or can be provided at an inner rim of the cooking pot (20).

Said beverage device (10) can be provided with a button adapted to control the electricity powering of the electronic control unit and the heating means (42). An indicator light can be adapted to indicate the electrical powering derived from the button, an indicator light can be adapted to indicate the reaching of a predetermined temperature in the heating means measured by means of the infrared temperature sensor (50), and another light indicator can be adapted to indicate that the water (31) in the water reservoir (30) is under a certain level.

In a possible embodiment of the present invention, the cooking pot (20) or the heating means (42) can be lifted mechanically or electromechanically in an upwards direction during the cooking process or the after of the cooking process is done. The beverage device (10) can have lifting means which is arranged to lift the cooking pot during the cooking process. In another embodiment of the present invention, the beverage device (10) can have a raising means (70) which allows the heating means (42) to be lifted in such a way as to contact the cooking pot (20) to increase the thermal efficiency during the cooking process wherein said raising means (70) actuates the heating means (42) in downwards direction when the cooking process is completed. The raising means (70) comprise a mechanical arm in a communication with a motor which provides the contact of the heating means (42) with the bottom of the boiling pot (20) by a certain pressure force by moving in the upwards direction during the cooking process. In a possible embodiment, when the infrared temperature sensor (8) detects predefined temperature is reached, the electronic control unit lowers the heating means and cuts the connection with the cooking pot (20).

A beverage is prepared in the beverage device (10) by using a method comprises the following steps:
ingredients of the mixture (21) are added to the cooking pot (20) to make the beverage;
the cooking pot (20) in the beverage device (10) is placed;
the device (10) is actuated;
water is sprayed into the cooking pot (20);
the cooking process is actuated by transmitting energy to the heating means (42);
the temperature of the upper surface (23) of the mixture (21) in the cooking pot (20) is measured by means of the infrared temperature sensor (50) contactless;
the cooking process is terminated by cutting off the energy transmitted from the heating means (42) to the cooking pot (20) when a predefined temperature value is reached based on the temperature data obtained from the infrared temperature sensor (50).

Said beverage preparation method further comprises the following steps
the temperature between 30 and 100° C. is maintained for a period of time depending on the type of the beverage to be prepared; and
the cooking process is terminated by cutting off or reducing the energy transmitted from the heating means (42) to the cooking pot (20) before the temperature of the mixture (21) exceeds 100° C.

According to the present invention, the beverage device (10) can be used for the preparation of Turkish coffee, coffee, soup or milk-based beverages.

What is claimed is:

1. A beverage device for making a beverage, particularly a coffee-based beverage, comprising:
an electronic control unit;
a portable cooking pot having a bottom and an open top for receiving a mixture that is added to the portable cooking pot to make the beverage, wherein in the portable cooking pot a cooking process is performed;
a heating means for heating the portable cooking pot during the cooking process; and
an infrared temperature sensor (50) for contactless sensing a temperature in the portable cooking pot;
wherein the infrared temperature sensor is configured to detect a temperature of an upper surface of the mixture during the cooking process and the infrared temperature sensor is disposed in proximity to the portable cooking pot at a distance such as to allow a measurement of the temperature of the upper surface of the mixture contactless wherein the electronic control unit reduces or cuts off power transferred to the heating means when a predefined temperature value is reached based on a temperature value obtained from the infrared temperature sensor.

2. The beverage device according to claim 1, wherein an electronic circuit is configured to pause the cooking process by cutting off or reducing an energy transmission to the portable cooking pot when the mixture reaches the predetermined temperature wherein the portable cooking pot is maintained from 30 to 100° C. for a predefined period of time.

3. The beverage device according to claim 1, wherein the beverage device comprises a water reservoir for storing water and a pump, wherein the pump is adapted to transfer water in the water reservoir to the portable cooking pot.

4. The beverage device claim 1, wherein the beverage device comprises at least one spraying head, wherein the at least one spraying head enables a mixing of the mixture in the portable cooking pot by a water jet.

5. The beverage device according to claim 4, wherein the at least one spraying head comprises at least one spray opening through which the water jet passes wherein the at least one spray opening is configured to spray the water to the mixture at an angle (α) between 10 and 60 degrees relative to a longitudinal axis (X) of the beverage device before or during the cooking process.

6. The beverage device according to claim 1, wherein the beverage device comprises a temperature sensor, wherein the temperature sensor is arranged to measure and control a temperature of a bottom surface of the heating means thereby overheating of the heating means is eliminated.

7. The beverage device according to claim 1, wherein the beverage device comprises a stirrer which is suitable to be positioned in the portable cooking pot, and a drive means configured to actuate the stirrer wherein the drive means and the stirrer are configured in such a way that the stirrer is driven in order to mix the mixture in the portable cooking pot, through a magnetic drive effect.

8. The beverage device according to claim 7, wherein the electronic control unit is configured in such a way as to actuate the drive means, and therefore magnetically drive the stirrer at a speed to mix the mixture during the cooking process or before the cooking process in a specified period of time.

9. The beverage device according to claim 7, wherein the drive means comprises a drive portion in a magnetic communication with the stirrer and a motor, wherein the motor is electrically powered, a spindle of the motor rotationally drives the drive portion and rotationally driving the drive portion creates a rotary local magnetic field, collaborating with an embedded upper magnet of the stirrer and an embedded lower magnet of the drive portion and creating the rotary local magnetic field, collaborating with the embedded upper magnet of the stirrer and the embedded lower magnet as a result causes the stirrer to rotate.

10. The beverage device according to claim 1, wherein the beverage device comprises a switch which is configured to detect a placement of the portable cooking pot in the beverage device before the cooking process is started.

11. The beverage device according to claim 1, wherein the beverage device comprises a raising means which allows the heating means to be lifted in such a way as to contact the portable cooking pot to increase a thermal efficiency during the cooking process wherein the raising means actuates the heating means in downwards direction when the cooking process is completed.

12. The beverage device according to claim 1, wherein the electronic control unit has a temperature algorithm, wherein the temperature algorithm calculates an inner temperature value of the mixture and when the mixture boils during the cooking process with respect to the temperature of the upper surface of the mixture that is sensed by the infrared temperature sensor, wherein the temperature algorithm calculates the inner temperature of the mixture depends on a type of a beverage to be prepared and a type of the heating means.

13. The beverage device according to claim 1, wherein the infrared temperature sensor is disposed in the portable cooking pot for contactless sensing the temperature in the portable cooking pot and the heating means is disposed on a bottom portion of the portable cooking pot wherein the portable cooking pot is placed onto a stand during the cooking process.

14. A beverage preparation method by the beverage device according to claim 1, comprising:
a step of adding a plurality of ingredients of the mixture to the portable cooking pot to make the beverage;
a step of placing the portable cooking pot in the beverage device;
a step of actuating the beverage device;
a step of spraying water into the portable cooking pot;
a step of actuating the cooking process by transmitting an energy to the heating means;
a step of measuring the temperature of the upper surface of the mixture in the portable cooking pot by means of the infrared temperature sensor contactless;
a step of terminating the cooking process by cutting off the energy transmitted from the heating means to the portable cooking pot when the predefined temperature value is reached based on temperature data obtained from the infrared temperature sensor.

15. The preparation method according to claim 14, further comprising:
a step, wherein during the step a temperature between 30 and 100° C. is maintained for a period of time depending on a type of a beverage to be prepared; and
a step of terminating the cooking process by cutting off the energy transmitted from the heating means to the portable cooking pot before the temperature of the mixture exceeds 100° C.

16. The beverage device according to claim 9, wherein the electronic control unit is configured in such a way as to actuate the drive means, and therefore magnetically drive the stirrer at a speed to mix the mixture during the cooking process or before the cooking process in a specified period of time.

17. The beverage device according to claim 12, wherein an electronic circuit is configured to pause the cooking process by cutting off or reducing an energy transmission to the portable cooking pot when the mixture reaches the predetermined temperature wherein the portable cooking pot is maintained from 30 to 100° C. for a predefined period of time.

18. The beverage device according to claim 12, wherein the beverage device comprises water reservoir for storing water and a pump, wherein the pump is adapted to transfer a water in the water reservoir to the portable cooking pot.

19. The beverage device according to claim 12, wherein the beverage device comprises at least one spraying head, wherein the at least one spraying head enables a mixing of the mixture in the portable cooking pot by a water jet.

20. The beverage device according to claim 12, wherein the at least one spraying head comprises at least one spray opening through which the water jet passes wherein the at least one spray opening is configured to spray the water to the mixture at an angle (a) between 10 and 60 degrees relative to a longitudinal axis (X) of the beverage device before or during the cooking process.
